(19) United States
(12) Patent Application Publication
(10) Pub. No.: US 2024/0290937 A1
(43) Pub. Date: Aug. 29, 2024

(54) Designing Low Tortuosity Electrode through Pattern Optimization for Fast-Charging using Screen Printing

(71) Applicant: Northeastern University, Boston, MA (US)

(72) Inventors: Hongli Zhu, Newton, MA (US); Ying Wang, Boston, MA (US)

(21) Appl. No.: 18/589,258

(22) Filed: Feb. 27, 2024

Related U.S. Application Data
(60) Provisional application No. 63/487,356, filed on Feb. 28, 2023.

(51) Int. Cl. H01M 4/04; H01M 4/02; H01M 4/131; H01M 4/1391; H01M 4/525

(52) U.S. Cl. CPC H01M 4/0414; H01M 4/0404; H01M 4/131; H01M 4/1391; H01M 4/525; H01M 2004/021; H01M 2004/028

(57) ABSTRACT

Reduction in the tortuosity of electrodes is a favored strategy to enhance the fast-charging capability of lithium-ion batteries by optimizing the ion-transfer kinetics. A facile, low-cost, highly controllable, and high-output continual additive manufacturing roll-to-roll screen printing technology is disclosed herein to render customized vertical channels within electrodes. High-accuracy vertical channels were fabricated by applying as-developed inks, using LiNi_{0.6}Mn_{0.2}Co_{0.2}O₂, for example, as the cathode material. The optimized screen-printed electrode exhibited a seven-fold higher specific charge capacity (72 mAh/g) at a current rate of 6 C and superior stability compared with that of the conventional bar-coated electrode (10 mAh/g, 6 C) at a mass loading of 10 mg/cm².

### RELATED APPLICATION(S)

This application claims the benefit of U.S. Provisional Application No. 63/487,356, filed on Feb. 28, 2023. The entire teachings of the above application(s) are incorporated herein by reference.

### GOVERNMENT SUPPORT

This invention was made with government support under Grant Number DE-EE0009111 awarded by the Department of Energy. The government has certain rights in the invention.

### BACKGROUND

Reduction in the tortuosity of electrodes is a favored strategy to enhance the fast-charging capability of lithium-ion batteries (LIBs). In order to decrease the tortuosity of electrodes through channel creation, scientists have applied magnetic field application, extrusion, directional freeze drying, aligned templates loading, and sacrificial chemical materials usage. However, these methods are costly and have low yield rates, as well as their channels are hard to design and control precisely.

### SUMMARY

According to one embodiment, an electrode comprising a current collector and an electrode material coupled to the current collector is disclosed herein, the electrode material containing vertically aligned channels relative to the current collector.

According to one aspect, the edge distance of the electrode channels is from about 0.1 mm to about 2 mm.

According to another aspect, the diameter of the channels is from about 0.1 mm to about 1 mm.

According to another aspect, the channels are arranged in a staggered configuration.

According to yet another aspect, the diameter of the channels is about 0.1 mm and edge distance of the channels is about 0.2 mm.

Another aspect relates to the electrode having a specific charge capacity of at least about 30 mAh/g at a current rate of about 6 C.

Another aspect relates to the electrode having a mass loading of at least about 10 mg/cm².

In another aspect, the electrode comprises lithium, nickel, manganese or cobalt, or a combination thereof.

In another embodiment disclosed herein is a method of forming an electrode, comprising: a) loading a pattern on a roller screen, the pattern defining microchannels of the electrode; b) applying the roller screen to transfer an electrode ink to a current collector; and c) drying the electrode ink to produce an electrode material coupled to the current collector, the electrode material containing vertically aligned channels relative to the current collector, thereby forming the electrode comprising the electrode material and the current collector.

In an aspect, the material composing the roller screen is polymer or stainless steel.

In another aspect, the pattern is a staggered channel pattern.

In another aspect, the pattern has a channel diameter of from about 0.1 mm to about 1 mm.

In another aspect, the screen is coated with an emulsion with a thickness of from about 10 μm to about 40 μm.

In another aspect, the solid content of the ink is from about 65% to about 70%.

In another aspect, the material composing the current collector is stainless steel, titanium, aluminum, nickel, or copper, or a combination thereof.

In another embodiment disclosed herein is an electrode ink, comprising metal oxide, electrically conductive material, and binder.

In an aspect, the metal oxide comprises lithium oxide.

In another aspect, the metal oxide is a compound of LiNiₓMn_{y}Co_{1-x-y}O₂, wherein x is from about 0.5 to about 0.9.

In another aspect, the solid content of the ink is from about 65% to about 70%.

In another aspect, the electrically conductive material is carbon black, and the binder is polyvinylidene fluoride.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A: Advantages and conceptual design of the application of screen-printed low-tortuosity LIB electrodes. Schematic of lithium ions flowing through low-tortuosity and conventional bulk electrodes.

FIG. 1B: Schematic of ion pathways in channels fabricated via screen printing.

FIG. 2A: Screen printing inks. Schematic of the relationship between flow behavior and printing quality.

FIG. 2B1: Digital image of Ink 1.

FIG. 2B2: Digital image of D0.1-E0.2 patterns printed with Ink 1.

FIG. 2C1: Digital image of Ink 2.

FIG. 2C2: Digital image of D0.1-E0.2 patterns printed with Ink 2.

FIG. 2D: Thixotropy of two types of homemade screen printable inks. Thixotropy recovery rates and times were evaluated using a three-step thixotropy test via successively applying 0.1, 200, and 0.1 s⁻¹ shear rates in three intervals, 0-90, 90-100, and 100-200 s.

FIG. 2E: Viscosity of two types of homemade screen printable inks.

FIG. 2F: Stress of two types of homemade screen printable inks.

FIG. 2G: Modulus of two types of homemade screen printable inks.

FIG. 3A: Screen-printed staggered dot matrix electrodes with a channel diameter of 0.5 mm and an edge distance of 2.0 mm.

FIG. 3B: Screen-printed parallel dot matrix electrodes with a channel diameter of 0.5 mm and an edge distance of 2.0 mm.

FIG. 4A: Printability of multilayer screen-printed electrodes with a mass loading of 10 mg/cm². As-printed electrodes with equal channel edge distances of 2 mm and various channel diameters of 0.5, 0.7, and 1.0 mm. The scale bar is 0.5 cm for all images.

FIG. 4B: Printability of multilayer screen-printed electrodes with a mass loading of 10 mg/cm². As-printed electrodes with equal channel diameters of 0.1 mm and different channel edge distances of 0.2, 0.3, and 0.4 mm. The scale bar is 0.5 cm for all images.

FIG. 5A: Electrochemical performances of screen-printed electrodes in low resolution. All electrodes were prepared with Ink 1. Galvanostatic charge-discharge curves of the initial three cycles of the P1-D0.5-E2.0 electrode.

FIG. 5B: Electrochemical performances of screen-printed electrodes in low resolution. All electrodes were prepared with Ink 1. Nyquist plot of electrodes.

FIG. 5C: Electrochemical performances of screen-printed electrodes in low resolution. All electrodes were prepared with Ink 1. Nyquist plot of electrodes.

FIG. 5D: Electrochemical performances of screen-printed electrodes in low resolution. All electrodes were prepared with Ink 1. Rate performances of as-printed electrodes with different channel patterns of P1 and P2.

FIG. 5E: Electrochemical performances of screen-printed electrodes in low resolution. All electrodes were prepared with Ink 1. Rate performances of bar-coated and screen-printed electrodes possessing the same channel pattern, P1, with an edge distance of 2.0 mm and various channel diameters of 0.5, 0.7, and 1.0 mm.

FIG. 5F: Electrochemical performances of screen-printed electrodes in low resolution. All electrodes were prepared with Ink 1. Long-term cycling performance of screen-printed electrodes with same channel edge distance and different channel diameters.

FIG. 6: Tape peeling test of low-resolution screen-printed and bar-coated electrodes. All electrodes were prepared with Ink 1. The scale bar is 2 cm for all electrodes.

FIG. 7A: Electrochemical performances of screen-printed electrodes with P1 patterns in high resolution. All electrodes were prepared with Ink 2. Cyclic voltammetry (CV) curves of the screen-printed and bar-coated electrodes.

FIG. 7B: Galvanostatic charge-discharge curves of the initial three cycles of the P1-D0.1-E0.2 electrode.

FIG. 7C: Electrochemical performances of screen-printed electrodes with P1 patterns in high resolution. All electrodes were prepared with Ink 2. Nyquist plot.

FIG. 7D: Electrochemical performances of screen-printed electrodes with P1 patterns in high resolution. All electrodes were prepared with Ink 2. Rate performances of bar-coated and screen-printed high-resolution electrodes.

FIG. 7E: Electrochemical performances of screen-printed electrodes with P1 patterns in high resolution. All electrodes were prepared with Ink 2. Rate performances of P1-D0.1-E0.2 electrodes with different mass loadings.

FIG. 7F: Electrochemical performances of screen-printed electrodes with P1 patterns in high resolution. All electrodes were prepared with Ink 2. Long-term cycling performance of bar-coated and screen-printed electrodes.

FIG. 8: Nyquist plots of electrodes with a high solid resolution.

FIG. 9A: Charge curves at 20% depth of the charge of screen-printed P1-D0.1-E0.2 (solid line) and bar-coated electrodes (dashed line) at various current rates.

FIG. 9B: Potential gap at 20% depth of the charge of screen-printed P1-D0.1-E0.2 (solid line) and bar-coated electrodes (dashed line) at various current rates.

FIG. 10A1: SEM image of one layer printed electrode with staggered channel matrix. Top view of P1-D0.1-E0.2 electrode. The scale bar is 100 μm.

FIG. 10A2: SEM image of one layer printed electrode with staggered channel matrix. Top view of P1-D0.1-E0.3 electrode. The scale bar is 100 μm.

FIG. 10A3: SEM image of one layer printed electrode with staggered channel matrix. Top view of P1-D0.1-E0.4 electrode. The scale bar is 100 μm.

FIG. 10B1: SEM image of one layer printed electrode with staggered channel matrix. Closer top view of P1-D0.1-E0.2 electrode. The scale bar is 100 μm.

FIG. 10B2: SEM image of one layer printed electrode with staggered channel matrix. Closer top view of P1-D0.1-E0.3 electrode. The scale bar is 100 μm.

FIG. 10B3: SEM image of one layer printed electrode with staggered channel matrix. Closer top view of P1-D0.1-E0.4 electrode. The scale bar is 100 μm.

FIG. 10C1: SEM image of one layer printed electrode with staggered channel matrix. Cross section of P1-D0.1-E0.2 electrode. The scale bar is 100 μm.

FIG. 10C2: SEM image of one layer printed electrode with staggered channel matrix. Cross section of P1-D0.1-E0.3 electrode. The scale bar is 100 μm.

FIG. 10C3: SEM image of one layer printed electrode with staggered channel matrix. Cross section of P1-D0.1-E0.4 electrode. The scale bar is 100 μm.

FIG. 11: Scanning electron microscopy (SEM) image of the electrode covered area of P1-D0.1-E0.4 as the printed electrode.

FIG. 12A: Channel enlarges during the drying process with P1-E1.0-D2.0 channel design at room temperature. The scale bar is 0.2 mm.

FIG. 12B: Channel enlarges during the drying process with P2-E1.0-D2.0 channel design at room temperature. The scale bar is 0.2 mm.

FIG. 12C: Channel enlarges during the drying process with P1-E0.7-D2.0 channel design at room temperature. The scale bar is 0.2 mm.

FIG. 12D: Channel enlarges during the drying process with P2-E0.7-D2.0 channel design at room temperature. The scale bar is 0.2 mm.

FIG. 12E: Channel enlarges during the drying process with P1-E0.5-D2.0 channel design at room temperature. The scale bar is 0.2 mm.

FIG. 12F: Channel enlarges during the drying process with P2-E0.5-D2.0 channel design at room temperature. The scale bar is 0.2 mm.

FIG. 13: Plots of the channel diameter enlarging ratio of various channel designs.

FIG. 14A: Lithium distribution in screen-printed channel-integrated electrodes at various charging and discharging stages. Top view of pristine, 50% charge, 100% charge, 50% discharge, and 100% discharge electrodes. The diameter of the channels is 0.1 mm, and the edge distance of the channels is 0.2 mm.

FIG. 14B: Lithium distribution in screen-printed channel-integrated electrodes at various charging and discharging stages. Cross-sectional view of pristine, 50% charge, 100% charge, 50% discharge, and 100% discharge electrodes. The red region in the figures represents enriched lithium, while the blue region corresponds to diminishing Li. The diameter of the channels is 0.1 mm, and the edge distance of the channels is 0.2 mm. Scale bars are 1 mm.

FIG. 15: Schematic of the cross-sectional view of electrodes in FIG. 14.

FIG. 16A: Summary of effects of vertical channel diameter and edge distance on screen printing difficulty.

FIG. 16B: Summary of effects of vertical channel diameter and edge distance on fast-charging capacity.

FIG. 16C: Low-tortuosity electrode fabrication processes through screen printing on laboratory- and industry-scale, and battery assembly and application of this technology in electric vehicles.

FIG. 17: Digital images of screen-printed electrodes in large areas of 3×5 cm×15 cm with a pore diameter of 0.1 mm and edge distance of 0.2, 0.3, and 0.4 mm using AMI M-465 flat screen printer. The scale bar is 2 mm for all electrodes.

FIG. 18: Schematic of R2R screen printing.

The foregoing will be apparent from the following more particular description of example embodiments, including those illustrated in the drawings interspersed herein. The drawings are not necessarily to scale, emphasis instead being placed upon illustrating embodiments.

### DETAILED DESCRIPTION

A description of example embodiments follows.

The steadily expanding electric vehicle market requires the development of fast-charging technology for lithium-ion batteries (LIBs) to drastically increase the battery capacity at high charge densities.^{[1, 2]} In addition to investigating a new generation of materials,^{[3]} optimizing the structure of the electrodes can help realize substantial enhancement in the capacity of LIBs at high current rates.^{[4]} Reducing the tortuosity of electrodes is a widely accepted structure modification strategy, as this results in superior charge transfer kinetics and excellent specific capacity at high current densities compared to conventional bulk electrodes.^{[1, 6]} Creating vertical channels is a straightforward strategy to reduce the tortuosity of electrodes.

In addition to reducing the tortuosity of the electrodes, the pattern, diameter, and edge distance of the channels determine the charge transport kinetics of the electrodes. The transport kinetics not only affect the polarization and rate capabilities of electrodes but also eventually have a profound impact on the stability and safety of the electrodes.^{[7]} Although previous reports claimed that the increase in channel density contributes to the rate performance of low-tortuosity electrodes for fast-charging LIBs,^{[8-10]} a comprehensive and detailed analysis of the relationship between channels and the electrochemical performance of LIBs is lacking. The understanding of this relationship allows for the design of structures that optimizes the electrode and maximize the capacity of fast-charging LIBs in the future.

Currently, roll-to-roll (R2R) screen printing is a promising approach for the precise architectural design of electrodes, as it can effortlessly create the pattern, diameter, and edge distance of the vertical channels within as-printed products.^{[11-13]} Through this technology, the underlying relationship between the charge transport kinetics and the internal electrode structure can be precisely studied. In addition to optimizing the architecture with high precision, R2R screen printing can be integrated into existing industrial electrode manufacturing production processes.^{[14]} Compared with the existing scalable direct channel fabrication E9, 15-171 and post treatment methods,^{[18]} industrial R2R screen printing is simple, highly productive, controllable, and economical for mass manufacturing low-tortuosity electrodes. As a continuous additive manufacturing process, R2R screen printing increases the mass loading of the electrodes through a facile layer-by-layer printing process, which possesses higher yield and efficiency than traditional peer-to-peer three-dimensional printing technology.^{[19, 20]} Unlike reduced material manufacturing, including laser^{[10]} and chemical etching,^{[18]} R2R screen printing does not generate waste and can effectively reduce cost and environmental pollution.

The present disclosure generally relates to electrodes comprising current collector and electrode material coupled to the current collector, the electrode material containing aligned (e.g., vertically aligned) channels with respect to the current collector. In embodiments, the electrode material comprises active material, electrically conductive material, and binder. The present disclosure also relates to methods of forming the electrodes, and compositions (e.g., electrode ink) for forming the electrodes. Vertically aligned channels decrease the ion transport pathway within the electrode, thereby accelerating the mass transport of the electrolyte and reducing the tortuosity of the electrode. In embodiments, the electrode is an electrode formed by a printing process (e.g., screen printing, 3D printing). The printing process may be combined with one or more processes, such as but not limited to calendering, reel-to-reel, web-fed continuous processing, and roll-to-roll (R2R) processes. For non-limiting example, the electrode is formed by R2R screen printing. In embodiments, the electrode is a screen-printed electrode (e.g., R2R screen-printed electrode).

The electrode of the present disclosure may be a cathode or anode of an electrochemical cell (e.g., lithium-ion battery). In a lithium-ion rechargeable battery, lithium ions are stored at the anode during the charging process. Discharging takes place and electric current is generated when lithium ions move from the anode to the cathode through the Li-ion conducting liquid electrolyte system.

The electrode channels may be arranged in a staggered or parallel configuration. In embodiments, the channels are arranged in a staggered configuration.

As defined herein, the edge distance of the channels refers to the average edge-to-edge distances between adjacent channels of the electrode. The edge distance, for non-limiting example, is from about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, about 0.1 mm to about 0.4 mm, about 0.1 mm to about 0.3 mm, or about 0.1 mm to about 0.2 mm. In alternative embodiments, the edge distance is about 0.2 mm.

The diameter of the electrode channels, for non-limiting example, is from about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, about 0.1 mm to about 0.4 mm, about 0.1 mm to about 0.3 mm, or about 0.1 mm to about 0.2 mm. In embodiments, the channel diameter is about 0.1 mm. In some embodiments, the electrode of the present disclosure comprises vertically aligned channels with channel diameter of about 0.1 mm and channel edge distance of about 0.2 mm.

The specific capacity (unit Ah/g) is a measure of the amount of charge that can be reversibly stored per unit mass of electrode material. In some embodiments, at a current rate of about 4 C, the electrode of the present disclosure has a specific charge capacity of at least about 10 mAh/g (e.g., at least about 20 mAh/g, at least about 30 mAh/g, at least about 40 mAh/g, at least about 50 mAh/g, at least about 60 mAh/g, at least about 70 mAh/g, or at least about 80 mAh/g). In some embodiments, at a current rate of about 4 C, the electrode of the present disclosure has a specific charge capacity of from about 10 mAh/g to about 150 mAh/g (e.g., about 20 mAh/g to about 150 mAh/g, about 30 mAh/g to about 150 mAh/g, about 40 mAh/g to about 150 mAh/g, about 50 mAh/g to about 150 mAh/g, about 60 mAh/g to about 150 mAh/g, about 70 mAh/g to about 150 mAh/g, about 80 mAh/g to about 150 mAh/g, about 80 mAh/g to about 140 mAh/g, about 80 mAh/g to about 130 mAh/g, about 80 mAh/g to about 120 mAh/g, about 80 mAh/g to about 110 mAh/g, about 90 mAh/g to about 110 mAh/g, or about 90 mAh/g to about 100 mAh/g). In some embodiments, at a current rate of about 6 C, the electrode of the present disclosure has a specific charge capacity of at least about 10 mAh/g (e.g., at least about 20 mAh/g, at least about 30 mAh/g, at least about 40 mAh/g, at least about 50 mAh/g, at least about 60 mAh/g, or at least about 70 mAh/g). In some embodiments, at a current rate of about 6 C, the electrode of the present disclosure has a specific charge capacity of from about 10 mAh/g to about 150 mAh/g (e.g., about 20 mAh/g to about 150 mAh/g, about 30 mAh/g to about 150 mAh/g, about 30 mAh/g to about 140 mAh/g, about 30 mAh/g to about 130 mAh/g, about 30 mAh/g to about 120 mAh/g, about 30 mAh/g to about 110 mAh/g, about 30 mAh/g to about 100 mAh/g, about 30 mAh/g to about 90 mAh/g, about 40 mAh/g to about 80 mAh/g, about 44 mAh/g to about 72 mAh/g, about 57 mAh/g to about 72 mAh/g, about 70 mAh/g to about 80 mAh/g, or about 70 mAh/g to about 75 mAh/g).

As used herein, the mass loading (unit mg/cm²) of an electrode refers to the amount of active material per unit area of the electrode. The electrode has a mass loading of, for non-limiting example, at least about 1 mg/cm² (e.g., at least about 5 mg/cm², at least about 10 mg/cm², at least about 15 mg/cm², at least about 20 mg/cm², at least about 25 mg/cm², or at least about 30 mg/cm²). In some embodiments, the electrode has a mass loading of from about 1 mg/cm² to about 100 mg/cm² (e.g., about 1 mg/cm² to about 50 mg/cm², about 1 mg/cm² to about 40 mg/cm², about 1 mg/cm² to about 30 mg/cm², about 1 mg/cm² to about 20 mg/cm², or about 5 mg/cm² to about 15 mg/cm²). In other embodiments, the electrode has a mass loading of about 10 mg/cm².

The electrode of the present disclosure comprises a current collector, which facilitates the flow of electrons between the electrode and the external circuit. For non-limiting example, the current collector is a substrate on which a composition comprising an active material (e.g., anode-active or cathode-active material) is applied. In embodiments, the composition is an electrode ink. The composition may comprise of solid content (e.g., active material, binder, electrically conductive material), and non-solid content (e.g., solvent). The material composing the current collector may be metal in the form of, for non-limiting example, a metal foil or a metal grid. In some embodiments, the metal is nickel, titanium, aluminum, stainless steel or copper, or a combination thereof. For non-limiting example, the current collector of the cathode may be made of aluminum. For non-limiting example, the current collector of the anode may be made of copper.

Active materials include, for non-limiting example, compounds containing Li, Ni, Mn, Co, Mg, Zn, Al, Ga, W, Zr, Ti, Ca, Ce, Fe, Y, or Nb, or a combination thereof (e.g., LiFePO₄, LiCoO₂, LiNiO₂, Li₄Ti₅O₁₂, Li₇Ti₅O₁₂ and LiMn₂O₄). In embodiments, the active material is a metal oxide or a metal phosphate, or a combination thereof. In some embodiments, the active material comprises Li, Ni, Mn, or Co, or a combination thereof. In some embodiments, the active material is a compound of LiNiₓMn_{y}Co_{1-x-y}O₂, wherein x is from about 0.5 to about 0.9 (e.g., from about 0.5 to about 0.8, from about 0.5 to about 0.7, from about 0.5 to about 0.6, or from about 0.6 to about 0.7), and wherein y is from about 0.1 to about 0.5 (e.g., from about 0.1 to about 0.4, from about 0.1 to about 0.3). In some embodiments, the active material is LiNi_{0.6}Mn_{0.2}Co_{0.2}O₂. The active material may be present in an amount of from about 10 wt % to about 99 wt % (e.g., about 20 wt % to about 99 wt %, about 50 wt % to about 99 wt %, about 60 wt % to about 99 wt %, about 70 wt % to about 99 wt %, about 80 wt % to about 99 wt %, about 90 wt % to about 99 wt %, or about 90 wt % to about 95 wt %) based on the total weight of the solid content of the composition. In some embodiments, the active material (e.g., metal oxide) is present in the composition in an amount of about 92 wt % based on the total weight of the solid content of the composition.

In some embodiments, the electrode of the present disclosure comprises Li, Ni, Mn, Co, Mg, Zn, Al, Ga, W, Zr, Ti, Ca, Ce, Fe, Y, or Nb, or a combination thereof. In some embodiments, the electrode of the present disclosure comprises lithium, nickel, manganese or cobalt, or a combination thereof.

The composition (e.g., electrode ink) applied on the current collector may further comprise one or more binders such as but not limited to polyvinylidene fluoride, polyethylene oxide, polyethylene, polypropylene, polytetrafluoroethylene, polyacrylates, or ethylene propylene diene monomer copolymer (EPDM), or blends and copolymers thereof. In some embodiments, the binder is polyvinylidene fluoride. The binder may be present in an amount of from about 1 wt % to about 50 wt % (e.g., about 1 wt % to about 40 wt %, about 1 wt % to about 30 wt %, about 1 wt % to about 20 wt %, about 1 wt % to about 15 wt %, about 1 wt % to about 10 wt %, or about 1 wt % to about 5 wt %) based on the total weight of the solid content of the composition. In some embodiments, the binder (e.g., polyvinylidene fluoride) is present in the composition in an amount of about 3 wt % based on the total weight of the solid content of the composition.

The composition may further comprise one or more electrically conductive materials, for non-limiting example, graphite, carbon black, carbon fibers such as graphite fibers and carbon nanotubes, metal powders such as silver powder, or metal fibers such as stainless-steel fibers and the like, or mixtures thereof. In some embodiments, the electrically conductive material is carbon black. The electrically conductive material may be present in an amount of from about 1 wt % to about 50 wt % (e.g., about 1 wt % to about 40 wt %, about 1 wt % to about 30 wt %, about 1 wt % to about 20 wt %, about 1 wt % to about 15 wt %, about 1 wt % to about 10 wt %, about 2 wt % to about 8 wt %, or about 3 wt % to about 7 wt %) based on the total weight of the solid content of the composition. In some embodiments, the electrically conductive material (e.g., carbon black) is present in the composition in an amount of about 5 wt % based on the total weight of the solid content of the composition. The one or more electrically conductive materials are different from the active materials.

In some embodiments, the composition (e.g., electrode ink) comprising active material, electrically conductive material, and binder are in a weight ratio of about 92:5:3. In one example embodiment, electrode ink comprising NMC 622 (ternary oxide with the chemical formula LiNi_{0.6}Mn_{0.2}Co_{0.2}O₂), Super P (carbon black), and PVDF (polyvinylidene fluoride), are in a weight ratio of about 92:5:3. In some aspects, the total weight of solid materials per batch of the electrode ink is about 3 g. Screen printing may be used to print the electrode ink on a current collector. The channel pattern/structure of the resulting electrode may be modified by changing the emulsion design of the screen.

The non-solid content of the composition comprises solvents, such as but not limited to ethylacetate, N-Methylpyrrolidine (NMP), dimethyl sulfoxide (DMSO), cyrene, γ-valerolactone, or dimethylformamide (DMF), or a combination thereof. In some embodiments, the composition comprises non-solid content in an amount of from about 10 wt % to about 50 wt % (e.g., 20 wt % to about 50 wt %, 30 wt % to about 50 wt %, about 30 wt % to about 40 wt %, or about 30 wt % to about 35 wt %). In other embodiments, the composition comprises non-solid content in an amount of about 32%.

In some embodiments, the composition comprises solid content in an amount of at least about 50 wt % (e.g., at least about 60 wt %, at least about 65 wt %, at least about 68 wt %, at least about 70 wt %, at least about 75 wt %, or at least about 80%). In some embodiments, the composition comprises solid content in an amount of from about 50 wt % to about 90 wt % (e.g., 50 wt % to about 80 wt %, 60 wt % to about 80 wt %, about 60 wt % to about 70 wt %, or about 65 wt % to about 70 wt %). In other embodiments, the composition comprises solid content in an amount of about 68%.

In some embodiments, at a shear rate of about 200 s⁻¹, the viscosity of the composition (e.g., electrode ink) is from about 2 Pa·s to 10 Pa·s (e.g., about 3 Pa·s to 10 Pa·s, about 4 Pa·s to 10 Pa·s, about 5 Pa·s to 10 Pa·s, about 6 Pa·s to 10 Pa·s, about 7 Pa·s to 9 Pa·s, about 7 Pa·s to 8 Pa·s, or about 7.0 Pa·s to 7.5 Pa·s). In some embodiments, at a shear rate of about 0.1 s⁻¹, the stress of the composition is from about 50 Pa to about 150 Pa (e.g., about 50 Pa to about 140 Pa, about 50 Pa to about 130 Pa, about 50 Pa to about 120 Pa, about 60 Pa to about 120 Pa, about 70 Pa to about 120 Pa, about 80 Pa to about 120 Pa, about 80 Pa to about 110 Pa, about 80 Pa to about 100 Pa, or about 90 Pa to about 100 Pa).

The present disclosure also relates to an electrochemical cell (e.g., lithium-ion battery) comprising an electrode of the present disclosure. In some embodiments, the electrochemical cell comprises an Li-ion conducting electrolyte system. In other embodiments, the electrochemical cell comprises an electrode of the present disclosure and an Li-ion conducting electrolyte system. In embodiments, the Li-ion conducting electrolyte system contains at least one nonaqueous solvent and at least one electrolyte salt containing Li ions.

The at least one nonaqueous solvent is, for non-limiting example, N-methylacetamide, acetonitrile, carbonates, sulfolanes, sulfones, N-substituted pyrrolidones, acyclic ethers, cyclic ethers, xylene, polyethers, or siloxanes, or combinations thereof. The carbonates include ethylene carbonate, ethyl methyl carbonate, fluoroethylene carbonate, methyl carbonate, ethyl carbonate and propyl carbonate; polyethers include, for example, glyme comprising diethylene glycol dimethyl ether (triglyme), tetraethylene glycol dimethyl ether (tetraglyme) and higher glyme, furthermore ethylene glycol divinyl ether, diethylene glycol divinyl ether, triethylene glycol divinyl ether, dipropylene glycol dimethyl ether and butylene glycol ether. In some embodiments, the non-aqueous solvent for the electrolyte system is ethylene carbonate or ethyl methyl carbonate, or a combination thereof.

Acyclic ethers include, for non-limiting example, dimethyl ether, dipropyl ether, dibutyl ether, dimethoxymethane, trimethoxymethane, dimethoxyethane, triethoxymethane, 1,2-dimethoxypropane, and 1,3-dimethoxypropane. The cyclic ethers include tetrahydrofuran, tetrahydropyran, 2-methyltetrahydrofuran, 1, 4-dioxane, trioxane and dioxolanes.

Electrolyte salts containing Li ions include, for non-limiting example, LiPF₆, LiBF₄, LiB(C₆H₅)₄, LiSbF₆, LiAsF₆, LiClO₄, LiCF₃SO₃, Li(CF₃SO₂)₂N, LiC₄F₉SO₃, Li(CF₃SO₂)₂N, or mixtures thereof.

In some embodiments, the Li-ion conducting electrolyte system comprises LiPF₆, ethylene carbonate (EC) and ethyl methyl carbonate (EMC). In some aspects, ethylene carbonate (EC) and ethyl methyl carbonate (EMC) are present in the electrolyte system in a weight ratio of about 3:7.

Also disclosed herein are methods of forming an electrode of the present disclosure, comprising one or more of the following: a) loading a pattern (e.g., staggered, parallel) on a screen (e.g., roller screen), the pattern defining microchannels of the electrode; b) applying the screen (e.g., roller screen) to transfer an electrode ink to a current collector; and c) drying the electrode ink to produce an electrode material coupled to the current collector, thereby forming the electrode comprising the electrode material and the current collector. In some embodiments, drying the electrode ink produces an electrode material containing vertically aligned channels relative to the current collector. In some embodiments, the material composing the screen (e.g., roller screen) is a polymer or a metal (e.g., stainless steel). In some embodiments, the material composing the screen is stainless steel. In some embodiments, the screen pattern is a staggered pattern.

For non-limiting example, the screen pattern has a channel diameter of from about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 mm to about 0.4 mm, about 0.1 mm to about 0.3 mm, or about 0.1 mm to about 0.2 mm. In some embodiments, the pattern has a channel diameter of from about 0.1 mm to about 1 mm. In some embodiments, the pattern has a channel diameter of about 0.1 mm.

In some embodiments, the screen pattern has a channel edge distance of from about 0.1 mm to about 5 mm (e.g., about 0.1 mm to about 4 mm, about 0.1 mm to about 3 mm, about 0.1 mm to about 2 mm, about 0.1 mm to about 1 mm, about 0.1 mm to about 0.9 mm, about 0.1 mm to about 0.8 mm, about 0.1 mm to about 0.7 mm, about 0.1 mm to about 0.6 mm, about 0.1 mm to about 0.5 mm, or about 0.2 mm to about 0.4 mm).

In embodiments, the screen thickness is from about 10 μm to about 50 μm (e.g., about 15 μm to about 50 μm, about 20 μm to about 50 μm, about 20 μm to about 45 μm, about 20 μm to about 40 μm, about 25 μm to about 40 μm, about 25 μm to about 35 μm, or about 25 μm to about 30 μm). In some embodiments, the screen thickness is 28 μm.

The mesh size of the screen may be, for non-limiting example, from about 200 to about 1200, about 200 to about 1000, about 200 to about 800, about 200 to about 700, about 200 to about 600, about 200 to about 500, about 200 to about 400, about 300 to about 400, or about 300 to about 325.

Emulsions for printing (e.g., screen printing) may comprise polymers (e.g., polyvinyl alcohol and a copolymer of polyvinyl acetate) which cross-link when exposed to actinic radiation sources, i.e., sources that produce light in the visible and/or ultraviolet frequencies. For non-limiting example, the screen is coated with an emulsion with a thickness of from about 1 μm to about 100 μm, about 1 μm to about 90 μm, about 1 μm to about 80 μm, about 1 mm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 10 μm to about 20 μm. In some embodiments, the screen is coated with an emulsion with a thickness of from about 10 μm to about 40 μm. In some embodiments, the screen is coated with an emulsion with a thickness of about 15 μm.

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed disclosure and disclosure. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

Those skilled in the art will recognize, or be able to ascertain, using no more than routine experimentation, numerous equivalents to the specific substances and procedures described herein. Such equivalents are intended to be encompassed in the scope of the claims that follow the examples below.

### Example Features

The following are example features of the technology described herein:
Compared to all published methods, roll-to-roll (R2R) screen printing electrodes is a low-cost, simple, and high-output approach to creating channels for electrodes.
This technology can be integrated into existing battery manufacturing.
Compared to other methods, R2R screen printing electrodes can precisely control the patterns while avoiding material waste.
Through precise pattern design and control, the best pattern for fast-charging electrodes can be created.

### Example Advantages

The following are example advantages of the technology described herein:
The optimized screen-printed electrode exhibited a seven-fold higher specific charge capacity at a current rate of 6 C and superior stability compared with that of the conventional bar-coated electrode at a mass loading of 10 mg/cm².
Screen printing technology is cheap, simple, and easy to learn and promote.
The output of printed low-tortuosity electrodes described herein is much higher than the output of low-tortuosity electrodes created by other published methods.
Pattern control at a high resolution.

### Example Uses

The following are example uses of the technology described herein:
Fast-charging electric vehicles
Portable and wearable energy storage devices
Electrode architecture design and optimization for other purposes
Printing of battery components on integrated circuits
Flexible, printed and thin-film batteries
Wearable electronic devices

### EXAMPLES

### Example 1. Designing Low Tortuosity Electrode Patterns for Optimized Fast-Charging

Example 1 was published in Small Methods 2023, Vol. 7, Issue 4, 2201344 (DOI: 10.1002/smtd.20220 1344), which is incorporated herein by reference in its entirety.

Herein is proposed a combination of screen printing and battery electrode manufacturing to produce low-tortuosity electrodes for fast-charging LIBs industrialization. In particular, a series of tailored channels for the LiNi_{0.6}Mn_{0.2}Co_{0.2}O₂ cathode were designed and created to comprehensively understand the effects of the pattern, channel diameter, and channel edge distance on the electrochemical properties of the electrode. As a result, the optimized screen-printed electrodes exhibited two- and seven-fold higher specific charge capacity than conventional bar-coated electrodes at 4 and 6 C, respectively. Additionally, neutron computed tomography was applied to understand the Li distribution of the optimized screen-printed electrodes at different charge states during cycling. The results showed the channels can promote a uniform ion transfer and enhance the ion-transfer kinetics on the electrodes. Additionally, R2R screen printing can be applied to the industrial production of electrodes with a well-designed structure and aid in the commercialization of fast-charging batteries.

Materials. Polycrystalline NMC 622 was obtained from Nanoramic Laboratories. Super P and aluminum foil current collectors were procured from MTI Corporation. Homopolymer PVDF (Kureha 7200 with an average molecular weight of 6.3×10⁵ g mol⁻¹) was procured from Kureha Company. N-Methylpyrrolidine (NMP) was procured from Fisher Science Education. Before preparation of the ink, NMC 622 and Super P powders were dried for at least 12 hours (h) at 100° C., and the homopolymer PVDF was dissolved into NMP to achieve the concentration of 10 weight percent (wt. %). All materials were used without any additional treatment.

Ink preparation. All inks were prepared as NMC 622, Super P, and PVDF with weight ratios of 92:5:3 in the formulation and 3 g for a total weight of solid materials per batch. Herein, Ink 1 with 60% solid content and Ink 2 with 68% solid content were prepared to satisfy the various printing situations. All components were thoroughly mixed with a dual asymmetric centrifugal mechanism (DAC 330-100 Pro Speedmixer from FlakTek).

Screen printing. The pattern for electrode printing was designed using Adobe Illustrator software (Adobe Inc.). The low-resolution patterns with 0.5, 0.7, and 1.0 mm channel diameters and 2.0 mm edge distance were loaded on a 300 mesh polymer screen, and the thickness of the total screen and emulsion was around 60 μm for electrode printing. The high-resolution patterns with 0.1 mm channel diameter and 0.2 mm, 0.3 mm, and 0.4 mm edge distances were loaded on a 325 mesh stainless steel screen (Microscreen Inc.). The emulsion thickness was 15 μm, and the screen thickness was 28 μm. The aluminum foil was used as both the current collector and substrate to evaluate the electrochemical properties of the screen-printed electrodes.

Characterization methods. The morphology of the samples was observed by scanning electron microscope (SEM; Hitachi S4800) at 3 kV. Optical microscopy characterization of the printed channels during the drying process was done with an Olympus VANOX-T optical microscope. The rheological properties were measured by a discovery hybrid rheometer (Discovery HR-30) from TA-Instruments with a flat Peltier plate. The tape peeling method was performed using 3M 6122 MP Scotch Magic Tape under a standard of ASTM D3330, method A.

Neutron characterization. Neutron imaging was performed at the cold neutron imaging beamline (CG-1D) at the High Flux Isotope Reactor (HFIR) at Oak Ridge National Laboratory, USA. The washed electrodes with various SOC were stuck on a thin aluminum plate for neutron computed tomography (CT) scan. During the CT scan, the plate was mounted on a rotation stage to collect a 30 s exposure image at every 0.37° through a 0-360° rotation. The collected images were then loaded into MuhRec[21] for 3D volume reconstruction. The reconstructed volume was visualized and analyzed using Amira-Avizo 3D software.[22]

Electrochemistry characterization. All electrochemical measurements were tested at room temperature, and all electrodes were assembled in a 2025 coin cell set. The 80 μL Gen 2 (1.2 M LiPF₆ dissolved in EC:EMC=3:7 by weight), Celgard 2400, and lithium metal were separately used as an electrolyte, separator, and anode in the coin cells. The active materials mass loading of screen-printed and bar-coated electrodes was around 10.0 mg/cm². The electrochemical station (Biologic SP150) was applied to evaluate the EIS performance of coin cells in the frequency range of 1 MHz to 100 mHz at room temperature, and Biologic MPG2 was used to evaluate the cyclic voltammetry (CV) curves in the range of 2.8-4.3 V and the scan rate of 0.1 mV/s. LANDT 8-channel tester (Wuhan LAND Electronic Co., Ltd.) was used to perform galvanostatic tests. For all tests, the rate performances were evaluated by charging at different C rate, specifically 0.1 C for six cycles, then 0.5 C, 1 C, 2 C, 4 C, 6 C, and 0.1 C for five cycles, respectively, following discharging at the constant current rate of C/3. All the electrochemical tests were run at room temperature.

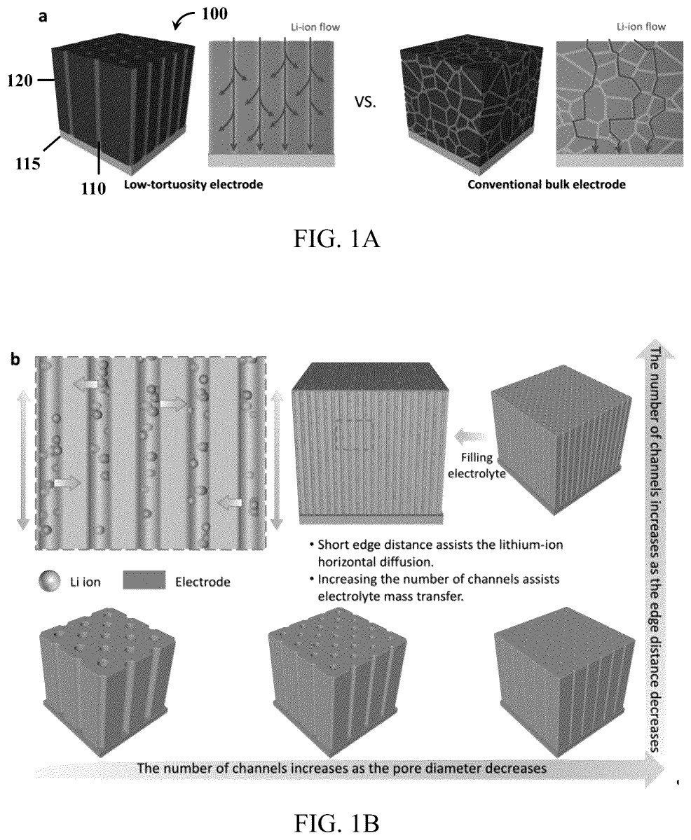

Artificially created channels within electrodes decrease the tortuosity of the electrodes. As shown in an example embodiment of the present disclosure illustrated in FIG. 1A, an ion transport pathway in an electrode 100 (comprising the electrode material 120 and current collector 115) relative to conventional bulk electrodes, was shortened by the vertically aligned channels 110 relative to the current collector 115, which accelerated the mass transport of the electrolyte therefore enhancing the rate performance of thick electrodes. In contrast, the ion transport pathway within conventional bulk electrodes is considerably extended, hindering electrochemical reactions and adversely affecting the rate performance of the thick electrodes. Furthermore, FIG. 1B schematically shows the underlying mechanism of the enhanced fast-charging performance due to the vertically aligned channels within the electrodes, which enhanced axial ion transfer and radial ion diffusion.

Excellent accessibility and wettability between active materials and electrolyte is a prerequisite for fast ions transportation and fast charge. The low tortuosity channels can improve the ion accessibility and shorten the ion movement distance in both lateral and axial directions. For the electrodes with channels, accessibility of the electrode and electrolyte depends on electrode thickness, channel diameter, and channel distance. The wettability depends on rheological properties of liquid electrolyte, and surface tension between electrode and electrolyte.

In this disclosure, the outstanding accessibility between low-tortuosity electrodes with large diameter channels and good wettability between low viscosity liquid electrolyte and electrode ensures superior ions transportation inside electrode channels. As lithium ions are considerably smaller than the channel diameter; expanding the channel diameter over 100 μm may have less benefits on the vertical ion transfer; conversely, a very large channel diameter directly decreases the energy density of the electrode. Consequently, reducing the channel diameter can effectively increase the density of the channels and facilitate vertical ion transport.

Compared with the diameter of the channels, the edge distance between the channels has a stronger impact on the fast charging of the electrodes. Reducing the edge distance not only increases the channel density to benefit axial ion transport but also shortens the lateral distance of ion diffusion and further enhances the ion-transfer efficiency. In addition to benefitting the ions transportation, small channels and short edge distances improve the active material density, which can further benefit the electric conductivity and mechanical stability of the whole electrode. As a result, channels with a small diameter and short edge distance simultaneously facilitate three-dimensional ion transfer, accelerate the electric conductivity of whole electrode, improve the electrode structural stability, and maintain a high volumetric energy density for batteries fast-charging, enable the electrode to achieve high energy density, high rate performance and durable cycling.

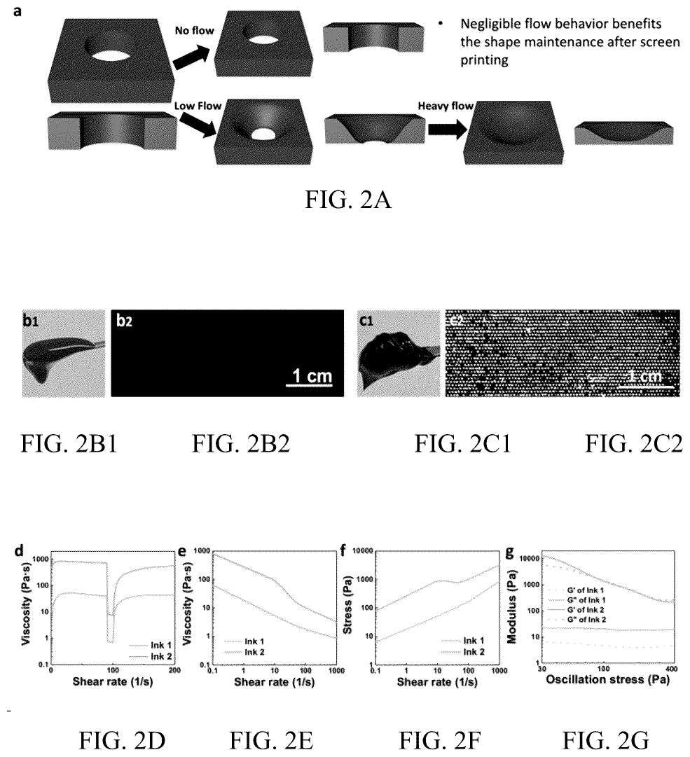

The effects of pattern and channel diameter on the electrochemical properties of electrodes were investigated at a low resolution. After screening the optimized pattern and channel diameter, the influences of the edge distances between the channels on the electrochemical performances of electrodes were understood at a high resolution with a channel diameter of 0.1 mm. Compared with low-resolution screen-printed electrodes, fabricating screen-printed electrodes with a high resolution is more challenging because the heavy flow of ink merges the channels (FIG. 2). To maintain the shape of the as-printed channels and avoid patterns merging after screen printing, the viscosity of the ink was increased from honey-like (Ink 1, FIG. 2B) to toothpaste-like (Ink 2, FIG. 2C) by increasing the solid content from 60% to 68%, and the screen material was changed from polymer to stainless steel. The rheological properties of the inks are shown and discussed in FIG. 2D-G. All printed electrodes displayed clear and well-arranged channels when compatible inks were used.

Both Ink 1 and Ink 2 demonstrate an ˜100% thixotropy recovery rate in 80 s (FIG. 2D), while Ink 2 exhibits considerably higher viscosity (7.2 Pa·s versus 1.3 Pa·s at a shear rate of 200 s⁻¹; FIG. 2E) and yield stress (FIG. 2F, 79.7 Pa versus 6.2 Pa) than Ink 1. Furthermore, the complex shear modulus curves (FIG. 2G) demonstrate that Ink 2 is viscoelastic because of the apparent gelation point at a stress of 200 Pa, whereas Ink 1 is not. The storage modulus (G′) of Ink 2 is lower than the loss modulus (G″), indicating viscous behavior during screen printing at high shear stress. After the squeegee moved away, the stress reduced, and the G′ of Ink 2 was higher than the G′, indicating elastic behavior, which maintains the shape of the high-resolution products.

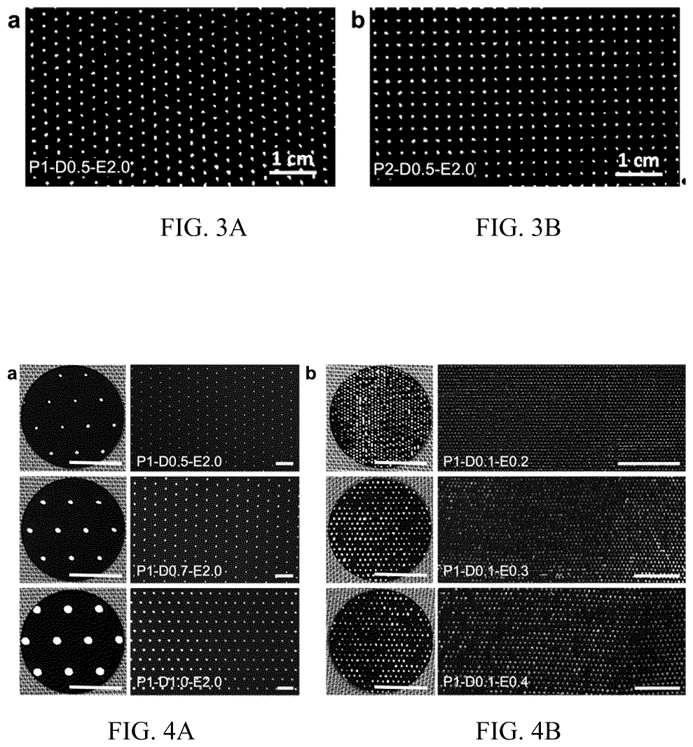

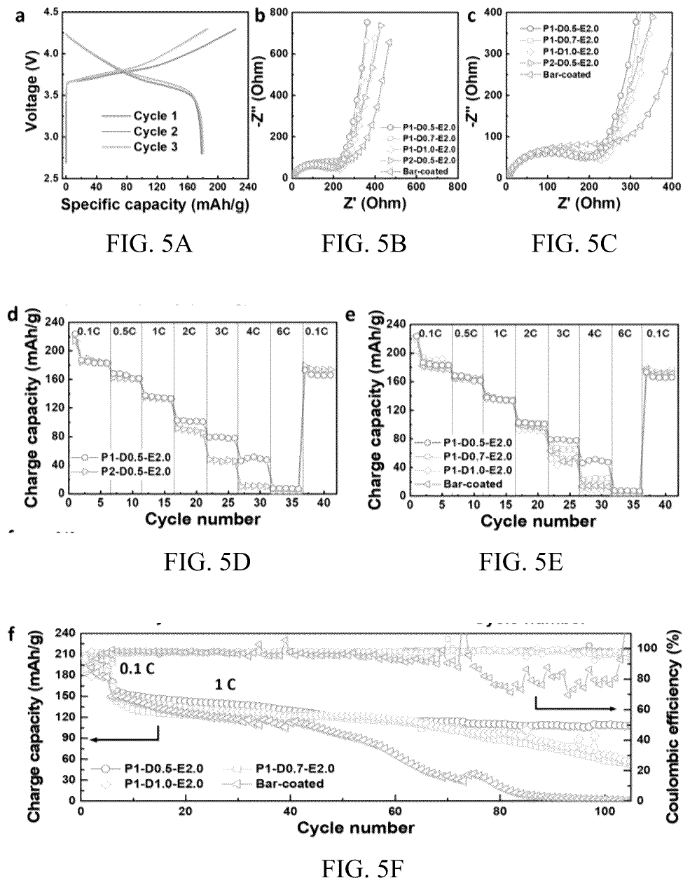

The staggered (P1) and parallel (P2) dot matrices with the same channel diameter (0.5 mm) and edge distance (2.0 mm) are shown in FIG. 3. The as-printed electrodes with the same channel edge distance of 2 mm and channel diameters of 0.5 mm, 0.7 mm, and 1.0 mm are displayed in FIG. 3A. The electrode material-coated regions were smooth, and the channels were clear, indicating the exceptional screen printability of the customized ink and the high printing quality of the electrodes. Subsequently, high-resolution electrodes with the same channel diameter (0.1 mm) and different edge distances (0.2 mm, 0.3 mm, and 0.4 mm) were printed, as shown in FIG. 4B. Most of the channels were visible at high resolution. To distinguish the patterns precisely, all the electrodes were labeled Pa-Db-Ec based on their: pattern (P), channel diameter (D), and edge distance (E), where a denotes the pattern category, and b and c denote the length of D and E at the millimeter level, separately, as shown in Tables 1 and 2.

TABLE 1
Low-resolution electrodes with a 2.0 mm edge distance

| | Diameter: | Diameter: | Diameter: |
|---|---|---|---|
| | 0.5 mm | 0.7 mm | 1.0 mm |
| Staggered pattern | P1-D0.5-E2.0 | P2-D0.7-E2.0 | P2-D1.0-E2.0 |
| Parallel pattern | P2-D0.5-E2.0 | | |

TABLE 2
High-resolution electrodes with a 0.1 mm channel diameter

| | Edge distance: | Edge distance: | Edge distance: |
|---|---|---|---|
| | 0.2 mm | 0.3 mm | 0.4 mm |
| Staggered pattern | P1-D0.1-E0.2 | P1-D0.1-E0.3 | P1-D0.1-E0.4 |

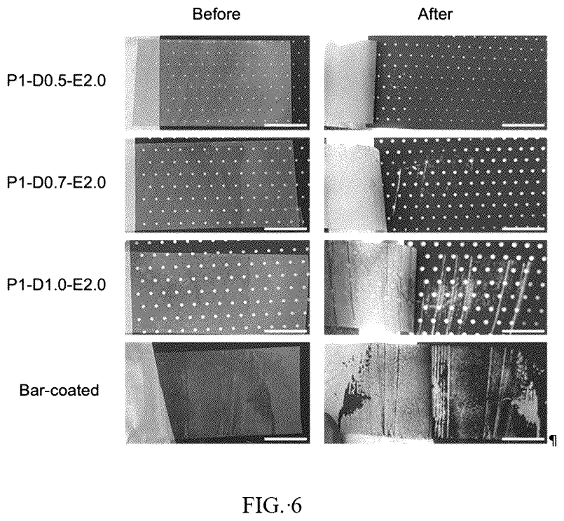

In order to evaluate the influences of the channel pattern and channel diameter within the printed electrodes, bar-coated and screen-printed low-resolution electrodes were prepared with Ink 1 and assembled in coin cells using lithium as the counter electrode. FIG. 5A shows the first three charge and discharge curves of the P1-D0.5-E2.0 electrode at a current rate of 0.1 C. The initial charge and discharge capacities of the P1-D0.5-E2.0 electrode were 223 and 179 mAh/g, respectively. The initial coulombic efficiency was 80.3%, which was influenced by the formation of a cathode electrolyte interface on the high specific surface of the as-printed electrode. The high-porosity structure and the large amounts of channels formed in the screen printing process are the main reasons for the increased specific surface area. The following two cycles displayed similar charge and discharge capacities with a coulombic efficiency of approximately 97.0%, indicating adequate stability. The Nyquist plots of the screen-printed electrodes with different channel patterns (FIG. 5B) show semicircles following the Warburg tails. The semicircles in the high-frequency area indicate the charge transfer resistance (FIG. 5C), and the Warburg tails in the low-frequency region represent the ion diffusion resistance. Evidently, the charge transfer resistances of the screen-printed electrodes were similar but were significantly lower than that of the bar-coated electrode.

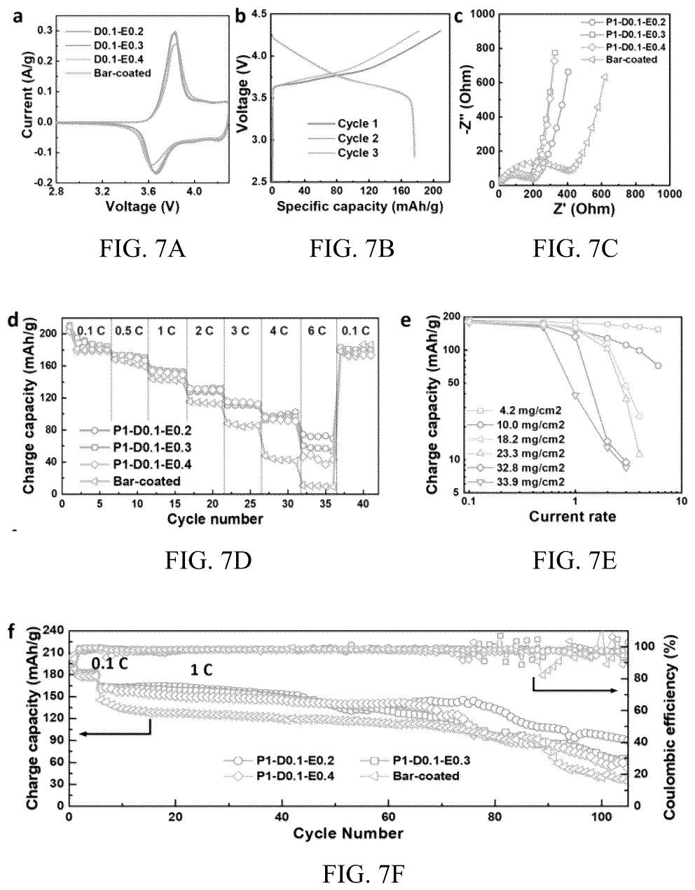

The rate performance of the electrodes was evaluated by charging at 0.1, 0.5, 1, 2, 4, and 6 C and discharging at C/3 (1 C equals 180 mA g⁻¹). A comparison of the rate performances of electrodes with different channel patterns wherein the voltage hold was applied during charging from 2 C to 6 C is shown in FIG. 5D, but the accompanying capacity is not included in the data. The P1-D0.5-E2.0 electrode exhibited higher rate capacities than the P2-D0.5-E2.0 electrode from a current rate of 2 C. At 4 C, the specific charge capacity of the P1-D0.5-E2.0 electrode was 49 mAh/g, which is significantly higher than that of the P2-D0.5-E2.0 electrode (8 mAh/g). Consequently, channels arranged in a staggered matrix render high capacities at high current rates because of the average shorter and more uniform distances between the channels. FIG. 5E illustrates the specific charge capacity when the channel pattern was staggered and the pore diameters of the electrode were 0.5, 0.7, and 1.0 mm. All the electrodes exhibited similar charge capacities of 184, 165, 135, and 102 mAh/g at current rates of 0.1, 0.5, 1, and 2 C, respectively. The advantage of an electrode with vertical channels is evident at high current rates of 3 and 4 C. In particular, P1-D0.5-E2.0 showed the highest specific charge capacity (49 mAh/g) among all the electrodes at a current rate of 4 C. The long-term stability of these electrodes was evaluated with a charge rate of 1 C and a discharge rate of C/3, as shown in FIG. 5F. Cells were activated by charging at 0.1 C and discharging at C/3 for five cycles. Among all the screen-printed electrodes, the P1-D0.5-E2.0 electrode displayed superior stability after 70 cycles, which is because more ink covered the current collector and the adhesion between the electrode and the current collector was stronger. Additionally, the coulombic efficiency of the P1-D0.5-E2.0 electrode was over 98.5% for the 100^{th} cycle. With the same ink, the bar-coated electrode displayed an unexpected vibration at 32 cycles and a rapid decline at 42 cycles, indicating poor stability. In contrast to the screen-printed electrodes, no vertical pressure was applied to the bar-coated electrodes during manufacturing, which led to a weak connection between the electrode and the current collector and destabilized its cycling stability. The mechanical stability of the electrode on the current collector was tested with the tape peeling method (FIG. 6), which shows an intensive dropping of particles in the bar-coated electrode. Comparatively, most solid particle remains for the P1-D0.5-E2.0 electrode.

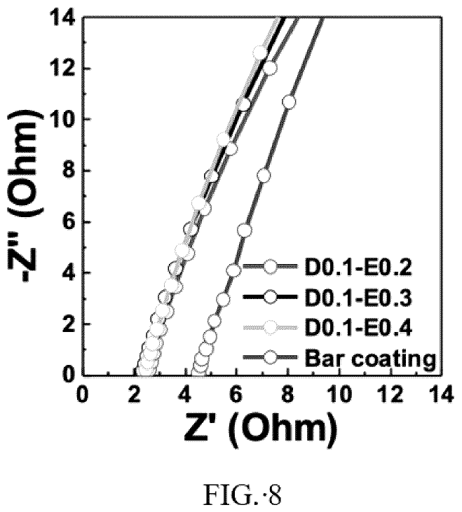

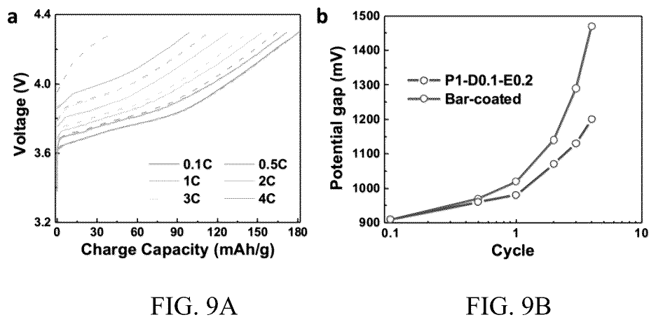

Following the previous filtering of the matrix and channel diameter of screen-printed electrodes, a staggered dot matrix (P1) with a channel diameter of 0.1 mm was selected as a channel pattern and channel diameter to optimize the rate performance of the screen-printed electrodes with channel edge distances of 0.2, 0.3, and 0.4 mm. A diameter of 0.1 mm is the smallest dot diameter currently available in industrial microscreen manufacturing for screen printing. The cyclic voltammetry (CV) curves of the screen-printed and bar-coated electrodes (FIG. 7A) show apparent oxidation (˜3.9 V) and reduction (˜3.6 V) peaks without significant additional peaks, suggesting the absence of side reaction during screen printing. Moreover, the screen-printed electrodes displayed smaller potential gaps than those of the bar-coated electrodes, indicating superior reaction kinetics and lower polarization. FIG. 7B shows the initial three galvanostatic charge and discharge curves of the P1-D0.1-E0.2 electrode at a current rate of 0.1 C. The initial specific charge capacity of the P1-D0.1-E0.2 electrode was 209 mAh/g, and the initial coulombic efficiency was 84.7%. The following two cycles exhibited a similar specific charge capacity of 182 mAh/g, suggesting reasonable stability of the P1-D0.1-E0.2 electrode. The Nyquist plots of the screen-printed high-resolution electrodes are shown in FIGS. 8 and 5C. The intercept distance and diameter of the semicircle indicate the bulk and charge transfer resistances of the electrodes, respectively. The bulk and charge transfer resistances of the screen-printed electrodes were similar, and both were smaller than those of the bar-coated electrodes. The charge transfer resistance reduction of screen-printed electrodes is consistent with the previous findings at low resolution (FIG. 5C) since the vertical channels created by screen printing can improve the charge transfer kinetics and reduce the charge transfer resistance of the electrodes.

The rate performances of the screen-printed and bar-coated electrodes are compared in FIG. 7D at charging current rates of 0.1, 0.5, 1, 2, 4, and 6 C and discharging at C/3. A voltage hold was applied during charging from 2 to 6 C, but the associated capacitance is not included in the data. The electrodes with channels exhibited superior charge capacities than the bar-coated electrode in the range of 0.5-6 C. With an increase in the current rate, the difference in the specific charge capacity of the electrodes enlarged. Although all the screen-printed electrodes exhibited similar specific charge capacities of 182, 169, 151, 130, 118, and 96 mAh/g at current rates of 0.1, 0.5, 1, 2, 3, and 4 C, respectively, the effect of the edge distance on the electrodes was visible at a high current rate of 6 C. When the current rate was increased to 6 C, the electrodes with channels exhibited charge capacities of 72, 57, and 44 mAh/g as the edge distances increased to 0.2, 0.3, and 0.4 mm, respectively. Notably, P1-D0.1-E0.2 exhibited the highest specific charge capacity among screen-printed electrodes, which is seven-fold higher than that of the bar-coated electrode (10 mAh/g) at 6 C.

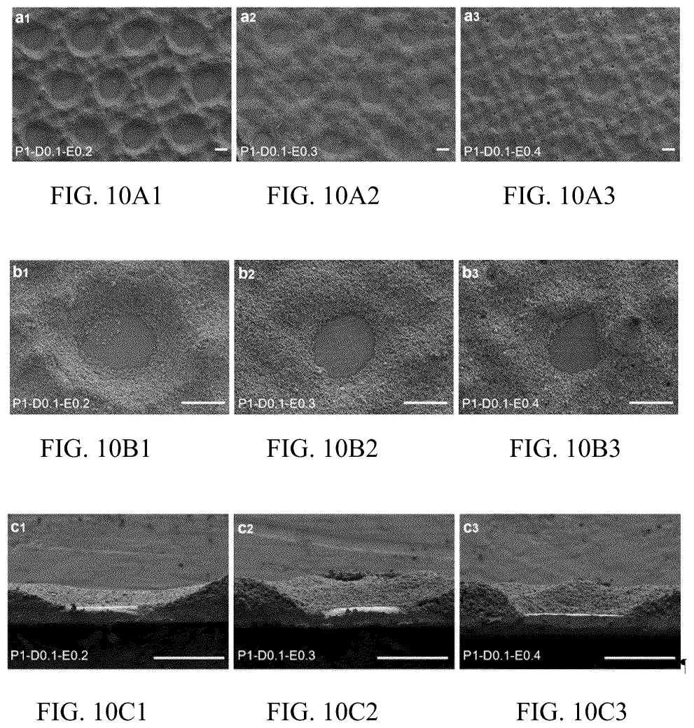

The charge curves of P1-D0.1-E0.2 and the bar-coated electrodes at various charging current rates are shown in FIG. 9A, and the potential gaps of the electrodes at the 20% state-of-charge (36 mAh/g) and the voltage cutoff (2.8 V) are shown in FIG. 9B. The bar-coated electrode showed a larger potential gap, and the difference increased with increasing current density, indicating superior electrochemical kinetics of the P1-D0.1-E0.2 electrode compared with that of the bar-coated electrode, particularly at high current rates. The rate performance of P1-D0.1-E0.2 electrodes with various mass loadings are compared in FIG. 7E, which shows the higher electrode mass loading following a more noticeable specific charge capacity decay with the current density elevating. With an increase in the mass loading, the thickness of the electrodes increased, which led to an increase in the charge transfer distance and a decrease in the charge transfer kinetics. The long-term cycling performances of the electrodes at a charge rate of 1 C and a discharge rate of C/3 are shown in FIG. 7F, and they were initially activated at 0.1 C for five cycles. Although all electrodes showed a notable capacity decline at approximately 85 cycles, P1-D0.1-E0.2 exhibited better stability. The superior stability of the screen-printed electrodes can be a result of the optimized channels mitigating the architectural damage to the electrodes from the lithium-ion insertion and stripping. The shorter the channel edge distance, the higher the channel density, and the irreversible collapse within the electrode is mitigated. Therefore, the poor structural stability of the bar-coated electrode results from the limited room available for alleviating the internal pressure during lithium-ion migration.

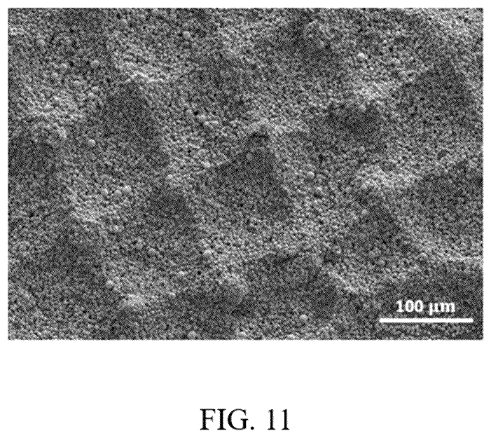

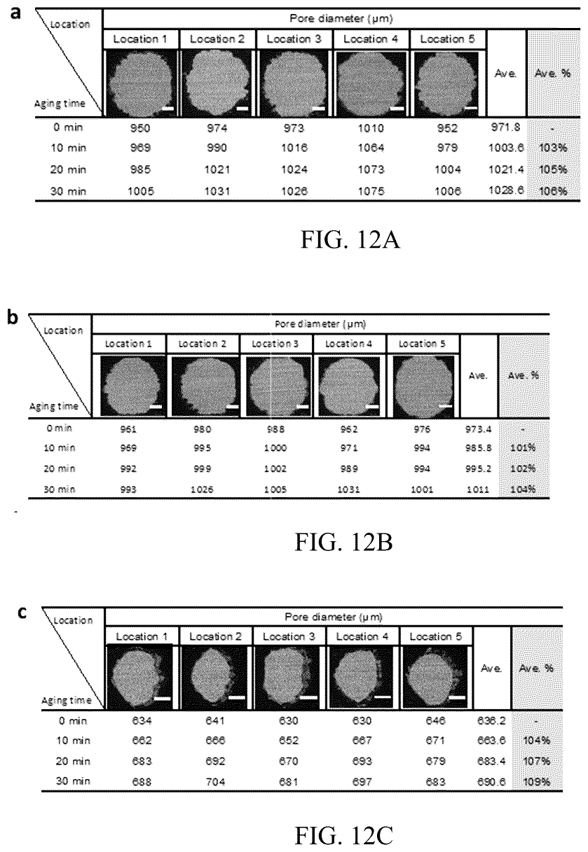

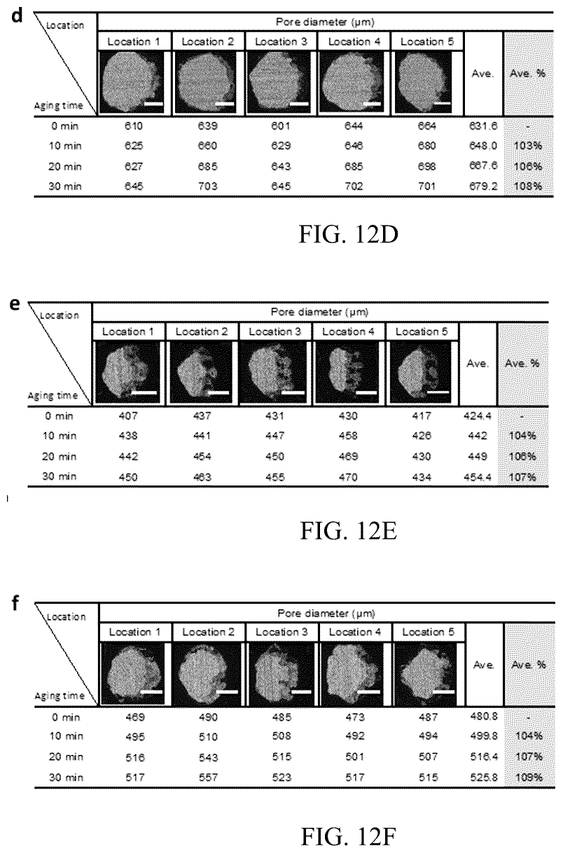

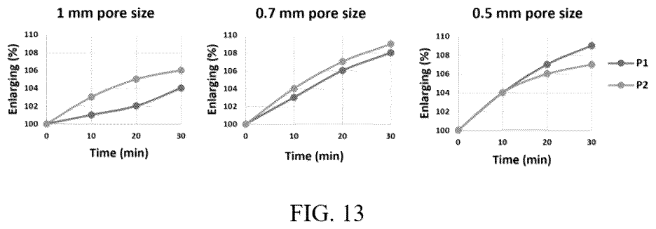

The morphology of the electrodes with high-resolution channels was further characterized using scanning electron microscopy (SEM). FIG. 10A1-A3 display the top view of the screen-printed channels. All the channels were clear, with a reasonable round shape, and consisted of a regular pattern, which is consistent with the pattern design. Regular bumpy craters were observed between the channels of the P1-D0.1-E0.3 (FIG. 10A2) and P1-D0.1-E0.4 (FIG. 10A3) electrodes. The magnified image (FIG. 11) of these bumpy craters shows neatly arranged similar deep square depressions with a length of approximately 80 μm. These craters are the imprints created by the low fluidity of the ink as it passes through the screen fibers. FIG. 10B 1-B3 display the channels of the corresponding electrodes at high magnification, and FIG. 10C1-C3 show their cross-sectional images. Bare aluminum foil areas were uncovered at the bottom of the printed electrodes. Since the inevitable shrinkage of the electrode material-covered area during the drying process, the diameter of the channels was slightly larger than 100 μm. The relationship between the electrode-covered area shrinkage and channel enlargement during the drying process of the low-resolution screen-printed electrodes is shown in FIGS. 12 and 13, respectively. Although patterns and diameter of channels affect the change ratio of screen-printed channels, the channel did expand by approximately 110% after 30 minutes of drying. Moreover, the channels exhibited a distinct bowl-like structure, resulting from the unavoidable flow of the ink.

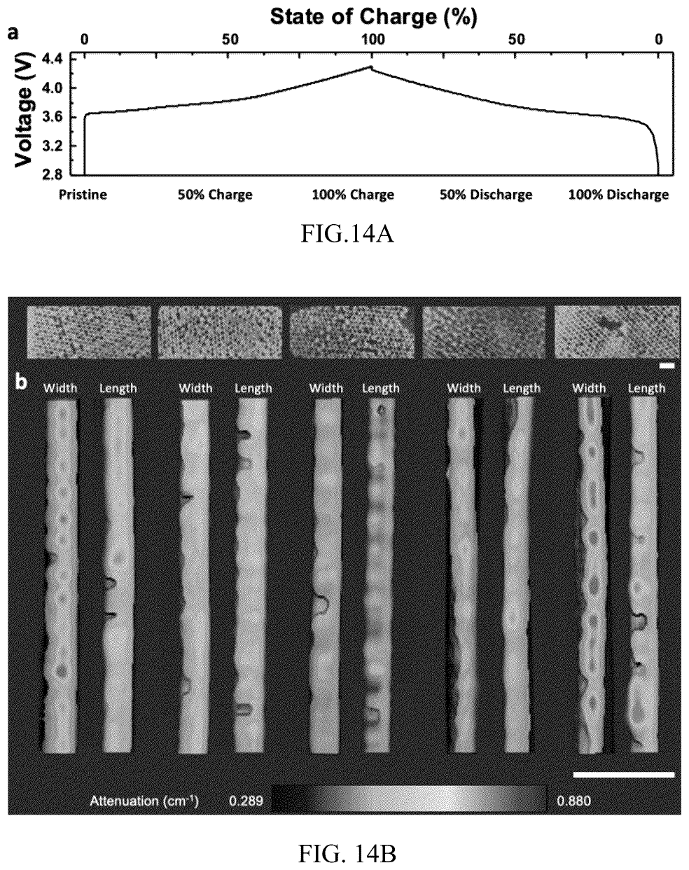

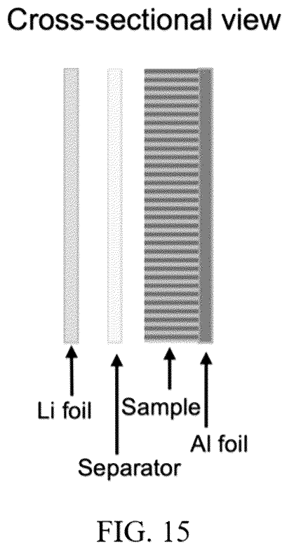

The exceptional rate performance of the screen-printed electrodes is attributed to the vertical channel, which effectively optimizes the lithium distribution during cycling. To understand the mechanism of channels in improving the specific charge capacity of screen-printed electrodes more intuitively, lithium distribution within the P1-D0.1-E0.2 electrodes was characterized using neutron computed tomography. FIG. 14A shows the lithium distribution within channels with longitudinally aligned electrodes at various states of charge. In FIG. 14B, the red color indicates the lithium-rich regions, and the greenish-blue represents regions with low lithium concentrations. FIG. 14B shows the lithium distribution in the aforementioned electrodes along their width (left to right) and length (top to bottom). With cathode delithiation, the red color weakens homogeneously. The electrode charged to 100% exhibited a large amount of blue region with a few yellow areas, indicating lithium extraction until charging was complete. With cathode lithiation, lithium diffused into the cathode, and a very strong red signal can be observed at the fully discharged electrode. Additionally, along the channel-built direction, the yellow and red areas show a regular rod-like distribution on the electrodes, suggesting that more lithium migrated along the channels. Meanwhile, the evenly colored signal of lithium (red and yellow) can be observed throughout the entire electrode, indicating that channels enabled the lithium distribution to be uniform from the separator side to the current collector side. FIG. 15 shows the assembly of the cells in detail. Consequently, the channel aids in preventing ions from singularly accumulating on the electrode surface and in enhancing the reaction kinetics on the current collector side of the electrodes during cycling. The enhanced mass transfer kinetics improve the capacitance of the electrodes, particularly at high current rates.

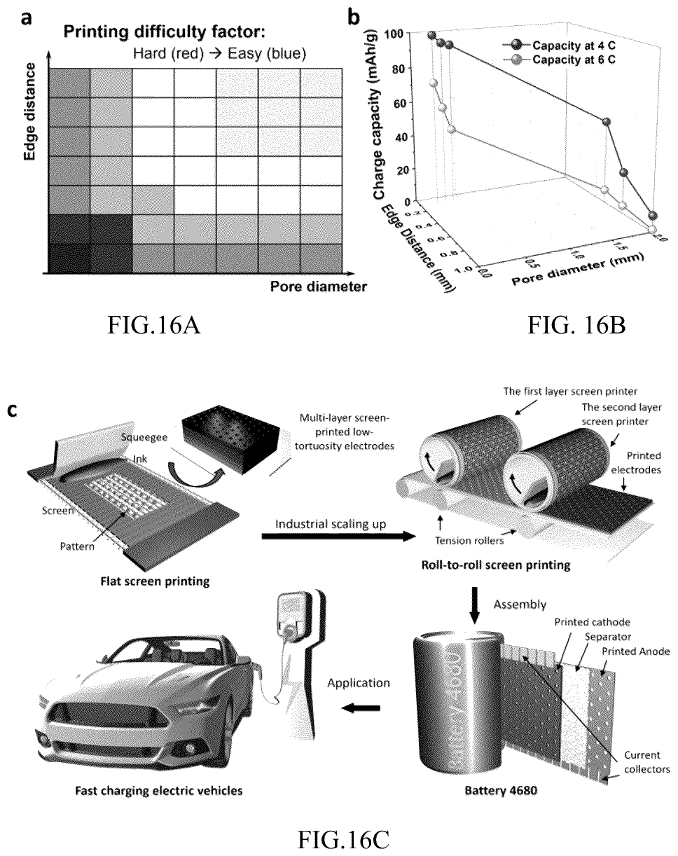

Although printed channels can improve electrode rate performance and structural stability, further printing specifics must be explored to realize the highest capability of the electrodes for industrialization. For example, although researchers expect to obtain high-accuracy and high-resolution printed products, the challenges in screen printing technology markedly increase as the resolution increases from the millimeter to micron level. Specifically, the diameter and edge distance of the customized channels directly affect the difficulty of printing in this work, a plot of which as a function of these variables is shown in FIG. 16A; the redder the color, the higher the printing difficulty. The printing difficulty increases as the channel diameter and edge distance reduce, which can be attributed to the three factors described next. First, an ultrahigh resolution of several micros is temporarily unattainable. Limited by the current technology, the wire diameter of commercially available metal mesh is limited to 18 μm with a mesh opening of 45 μm;^{[23]} the channel diameter is limited to ˜100 μm to ensure that a circular pattern emulsion is carried on two wires of the screen to maintain a stable shape before and after screen printing. Second, the ink should have low fluidity to avoid printed pattern merging and attain a high resolution. However, the lower fluidity indicates a tighter internal structure, and such a structure is resistant to being squeezed through the tiny gaps of fine screens. Third, the higher the resolution, the less accurate the design patterns will be because the fibers drag ink units and obstruct ink transfer to the current collector substrate during the printing process. The above results suggest that a smaller channel diameter and shorter edge distance between channels lead to better rate performance of screen-printed LIB electrodes at high current densities (FIG. 16B). Therefore, higher-resolution microscreen production and more investigations of the design of the channels in the electrodes are necessary to achieve a satisfactory fast-charging capacity.

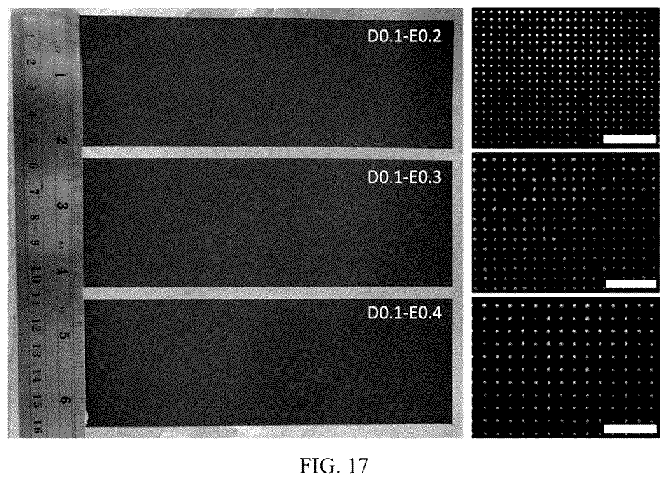

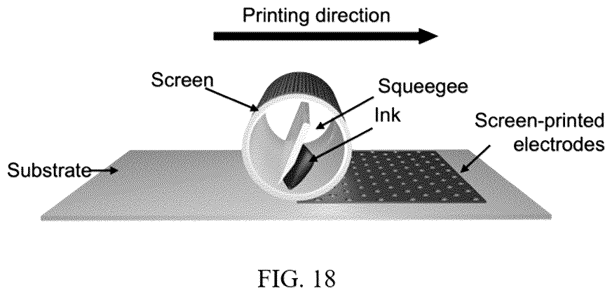

In addition to presenting a simple approach for investigating the channels within the electrodes and improving the electrochemical performance at high current rates, it is believed that screen printing can be integrated into existing production processes and satisfy industrial manufacturing requirements. As shown in FIG. 16C, screen-printable electrode inks were fabricated, customized channels within the electrodes were created through screen printing, and thickness and mass loading of the electrodes was increased by multiple printing. FIG. 17 exhibited the screen-printed electrodes in a large area with an advanced flat screen printer, demonstrating its potential to be industrialized. Similarly, the R2R screen printing can be applied to manufacture low-tortuosity electrodes, wherein the multi-roller can be assembled to enhance and control the mass loading of printed electrodes for commercialization. The details of an R2R screen printer are shown in FIG. 18, in which a squeegee and an ink tank are built into the roller screen. It is evident that the proposed continuous R2R screen printing battery manufacturing technology satisfies industrialization and commercialization requirements because it is facile to control and scalable with no material wastage or impurity introduction.

Conclusions. In this disclosure, an R2R screen printing technology was used to create tailored channels and impart a low-tortuosity architecture within electrodes, which can be used industrially in fast-charging LIBs. Applying a custom ink, screen-printed LIBs electrodes with customized channels of high resolution were successfully rendered. Further investigations showed that pattern, diameter, and edge distance between the channels affected the rate performance and stability of the electrodes. Specifically, channels with staggered patterns exhibited a higher rate performance than channels with parallel patterns. Concurrently, the fast-charging capacity of screen-printed electrodes increased with a reduction in the channel diameter and a shortening of the channel edge distance. Superior to the conventional bar-coated electrode, the screen-printed electrode with staggered channels with 0.1 mm diameter and 0.2 mm edge distance exhibited a seven-fold higher specific charge capacity at 6 C. During charging and discharging, lithium was evenly distributed along the whole channels, and the ion was effortlessly transferred to the side that connects to the current collector, which improved the rate performance of the screen-printed electrodes. Furthermore, the short edge distance between channels expedited the ion diffusion in the radial direction. As a facile, high-output, and cost-effective continuous additive manufacturing technique, R2R screen printing offers new opportunities for the industrial manufacture of fast-charging batteries and promises to accelerate the development of electric vehicles.

### REFERENCES

1. A. Tomaszewska, Z. Chu, X. Feng, S. O'Kane, X. Liu, J. Chen, C. Ji, E. Endler, R. Li, L. Liu, ETransportation 2019, 1, 100011.
2. S. Li, K. Wang, G. Zhang, S. Li, Y. Xu, X. Zhang, X. Zhang, S. Zheng, X. Sun, Y. Ma, Adv. Funct. Mater. 2022, 2200796.
3. M. Weiss, R. Ruess, J. Kasnatscheew, Y. Levartovsky, N. R. Levy, P. Minnmann, L. Stolz, T. Waldmann, M. Wohlfahrt-Mehrens, D. Aurbach, Adv. Energy Mater. 2021, 11 (33), 2101126.
4. Y. Kuang, C. Chen, D. Kirsch, L. Hu, Adv. Energy Mater. 2019, 9 (33), 1901457.
5. L. Shen, Z. Chen, Chem. Eng. Sci. 2007, 62 (14), 3748-3755.
6. T.-T. Nguyen, A. Demortière, B. Fleutot, B. Delobel, C. Delacourt, S. J. Cooper, Npj Comput. Mater. 2020, 6 (1), 1-12.
7. X. Zhang, Z. Ju, Y. Zhu, K. J. Takeuchi, E. S. Takeuchi, A. C. Marschilok, G. Yu, Advanced Energy Materials 2021, 11 (2), 2000808.
8. C. J. Bae, C. K. Erdonmez, J. W. Halloran, Y. M. Chiang, Adv. Mater. 2013, 25 (9), 1254-1258.
9. J. Sander, R. M. Erb, L. Li, A. Gurijala, Y.-M. Chiang, Nat. Energy 2016, 1 (8), 1-7.
10. J. Park, C. Jeon, W. Kim, S.-J. Bong, S. Jeong, H.-J. Kim, J. Power Sources 2021, 482,
11. H. Emani, X. Zhang, G. Wang, D. Maddipatla, T. Saeed, Q. Wu, W. Lu, M. Atashbar 2021 IEEE International Conference on Flexible and Printable Sensors and Systems (FLEPS), IEEE: 2021; pp 1-4.
12. S. Ahmadi, Y. Wang, D. Maddipatla, D. Cao, H. Zhu, Q. Wu, M. Atashbar 2022 FLEPS, IEEE: 2022; pp 1-4.
13. Y. Wang, J. He, D. Cao, E. Cakmak, X. Zhao, Q. Wu, Y. Zhao, H. Ren, X. Sun, Y. Li, Energy Stor. Mater. 2023, 55, 42-54.
14. Y. Wang, D. Cao, X. Sun, H. Ren, T. Ji, X. Jin, J. Morse, B. Stewart, H. Zhu, Adv. Mater. Technol., 2200303.
15. R. Xiong, Y. Zhang, Y. Wang, L. Song, M. Li, H. Yang, Z. Huang, D. Li, H. Zhou, Small Methods 2021, 5 (6), 2100280.
16. J. Billaud, F. Bouville, T. Magrini, C. Villevieille, A. R. Studart, Nat. Energy 2016, 1 (8), 1-6.
17. D. P. Singh, F. M. Mulder, A. M. Abdelkader, M. Wagemaker, Adv. Energy Mater. 2013, 3 (5), 572-578.
18. W. McSweeney, H. Geaney, C. O'Dwyer, Nano Research 2015, 8 (5), 1395-1442.
19. C. Costa, R. Gonçalves, S. Lanceros-Méndez, Energy Stor. Mater. 2020, 28, 216-234.
20. H. Tetik, Y. Wang, X. Sun, D. Cao, N. Shah, H. Zhu, F. Qian, D. Lin, Adv. Funct. Mater. 2021, 31 (45), 2103410.
21. D. Stalling, M. Westerhoff, H.-C. Hege, 38-amira: A Highly Interactive System for Visual Data Analysis. In Visualization Handbook, Hansen, C. D.; Johnson, C. R., Eds. Butterworth-Heinemann: Burlington, 2005; pp 749-767.
22. https_www_microscreenllc_com/frames-and-mesh. (accessed March 22).
23. A. P. Kaestner, Nuclear Instruments and Methods in Physics Research Section A. Accelerators, Spectrometers, Detectors and Associated Equipment 2011, 651 (1), 156 160.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. An electrode, comprising:
a current collector; and
an electrode material coupled to the current collector, the electrode material containing vertically aligned channels relative to the current collector.

2. The electrode of claim 1, wherein edge distance of the channels is from about 0.1 mm to about 2 mm.

3. The electrode of claim 1, wherein diameter of the channels is from about 0.1 mm to about 1 mm.

4. The electrode of claim 1, wherein the channels are arranged in a staggered configuration.

5. The electrode of claim 1, wherein diameter of the channels is about 0.1 mm and edge distance of the channels is about 0.2 mm.

6. The electrode of claim 1, wherein the electrode has a specific charge capacity of at least about 30 mAh/g at a current rate of about 6 C.

7. The electrode of claim 1, wherein the electrode has a mass loading of at least about 10 mg/cm².

8. The electrode of claim 1, comprising lithium, nickel, manganese or cobalt, or a combination thereof.

9. A method of forming an electrode, the method comprising:
a) loading a pattern on a roller screen, the pattern defining microchannels of the electrode;
b) applying the roller screen to transfer an electrode ink to a current collector; and
c) drying the electrode ink to produce an electrode material coupled to the current collector, the electrode material containing vertically aligned channels relative to the current collector,
thereby forming the electrode comprising the electrode material and the current collector.

10. The method of claim 9, wherein material composing the roller screen is polymer or stainless steel.

11. The method of claim 9, wherein the pattern is a staggered channel pattern.

12. The method of claim 9, wherein the pattern has a channel diameter of from about 0.1 mm to about 1 mm.

13. The method of claim 9, wherein the screen is coated with an emulsion with a thickness of from about 10 μm to about 40 μm.

14. The method of claim 9, wherein solid content of the ink is from about 65% to about 70%.

15. The method of claim 9, wherein material composing the current collector is stainless steel, titanium, aluminum, nickel, or copper, or a combination thereof.

16. An electrode ink, comprising metal oxide, electrically conductive material, and binder.

17. The ink of claim 16, wherein the metal oxide comprises lithium oxide.

18. The ink of claim 17, wherein the metal oxide is a compound of LiNiₓMn_{y}Co_{1-x-y}O₂, wherein x is from about 0.5 to about 0.9.

19. The ink of claim 16, wherein solid content of the ink is from about 65% to about 70%.

20. The ink of claim 16, wherein the electrically conductive material is carbon black, and wherein the binder is polyvinylidene fluoride.
